(19) United States
(12) Patent Application Publication
(10) Pub. No.: US 2004/0239110 A1
(43) Pub. Date: Dec. 2, 2004

(54) Support sleeve for use in a tube coupling and a coupling housing for use together with said sleeve

(76) Inventors: Egil Pedersen, Raufoss (NO); Jan Erik Sangro, Hamar (NO)

Correspondence Address: OSHA & MAY L.L.P., 1221 MCKINNEY STREET, HOUSTON, TX, 77010, US

(21) Appl. No.: 10/487,378

(22) PCT Filed: Aug. 19, 2002
(86) PCT No.: PCT/NO02/00281

(30) Foreign Application Priority Data
Aug. 21, 2001 (NO) 20014068

(51) Int. Cl. F16L 33/00; F16L 49/00

(52) U.S. Cl. 285/255; 285/340; 285/249

(57) ABSTRACT

A supporting sleeve that is to be used in a tube coupling. The supporting sleeve causes an internal stiffening against compression of the end of a tube inserted in the coupling. The supporting sleeve is a separate part that is mounted in a bore in the coupling. The supporting sleeve includes a deformable collar that externally is conical and narrows in the direction of insertion. The edge of the collar has a diameter mainly corresponding to or exceeding the diameter of the bore.

The invention relates to a supporting sleeve for use in a tube coupling and a tube coupling for use together with such a supporting sleeve, as disclosed in the preamble of the succeeding claims 1 and 9.

### PRIOR ART

Supporting sleeves are used in tube couplings, in particular in those which contain a clamping ring and/or a sealing ring, as an internal stiffening against compressing of a tube inserted in the coupling, in order to prevent that the tube collapses due to the pressure from outside exerted by the clamping ring and/or sealing ring. This may in particular occur when the tube is of a soft material, but also when the clamping ring and/or sealing ring exerts a high pressure against the outside of the tube. Thereby, the sealing around the tube and/or the retaining thereof may become insufficient.

NO Patent 149598 shows an example of a coupling which contains a supporting sleeve made integrally with a coupling housing.

Moreover, it is known to insert separate supporting sleeves in coupling housings. As examples reference is made to DE Patent Application 2450126, showing a supporting sleeve attached on the end of the tube inserted in the coupling housing in that the tube has internal grooves at the end. This solution makes it necessary to machine the tube end in order to form the grooves. EP Patent Application 0546405 shows a separate supporting sleeve having an end portion with a conical external shape, adapted to a conical surface in a coupling housing. Moreover, the end portion has an annular groove, into which the end of a tube can be inserted. The supporting sleeve will not be kept in place in the coupling housing before a second coupling housing has been screwed on.

With the present invention has been provided a supporting sleeve which in a simple manner is retained in a coupling housing upon insertion, and a tube coupling for use together with such a supporting sleeve.

The supporting sleeve and the tube coupling according to the invention are characterized by the features appearing from the preceeding claims 1 and 9. Embodiments of the supporting sleeve are specified in the claims 2-8.

### SUMMARY OF THE INVENTION

Because the supporting sleeve has a collar which is externally conical, the supporting sleeve may simply be inserted in a cylindrical bore in the coupling housing, and because the diameter of the collar in undeformed state of the collar exceeds the diameter of the bore, the collar will in inserted state form an obstruction against pulling out the supporting sleeve. The bore in the coupling housing may have an annular groove into which the edge of the collar will protrude. The collar may have a correspondingly increased radial dimension, whereby the collar is deformed in the mounted state of the supporting sleeve.

Preferably the coupling housing comprises a second bore in the succession of the bore into which the supporting sleeve is inserted, and this second bore is adapted to an extension of the supporting sleeve, whereby the supporting sleeve is centered in the coupling housing and aligned with the longitudinal axis of the coupling housing. Without such a second bore there is a possibility of inserting the supporting sleeve in such a manner that it is not exactly aligned with the longitudinal axis of the coupling housing, and the retaining of the supporting sleeve may be impaired. Moreover, the insertion of a tube in the coupling housing may be more difficult. The second bore and the extension of the supporting sleeve also cause that the supporting sleeve is kept centered along the longitudinal axis even if it is subjected to an external strain, such as impacts or strokes.

The invention will in the following be explained with reference to the accompanying drawings, which show longitudinal sections through examples of a coupling with a coupling housing containing a supporting sleeve, according to the invention.

### EXPLANATION OF THE DRAWINGS

FIG. 1 shows a coupling housing which contains a supporting sleeve according to the invention.

FIG. 2 shows a coupling socket which has been screwed onto the coupling housing and which contains a clamping ring and two O-rings, and a third O-ring is jammed between the coupling socket and the coupling housing.

FIG. 3 shows the coupling of FIG. 2 and the end of a tube having been inserted into the coupling.

FIG. 4 shows approximately the same as FIG. 2, and shows a coupling housing formed in accordance with the invention, somewhat differently shaped internally than the coupling housing shown in the FIGS. 1-3.

### DESCRIPTION OF EMBODIMENTS

The Figs. show a supporting sleeve 1 according to the invention, comprising a first cylindrical portion 2, an external conical collar 3 and an extension 4. The supporting sleeve 1 is shown mounted in a coupling housing 5, which in the example shown is formed with a nut portion 6, for instance with an external hexagonal shape in order to be screwed by means of a wrench. Moreover, the coupling housing 5 comprises a first, externally threaded stub 7 for screwing on of a coupling socket which in screwed-on state may contain a clamping ring and/or a sealing ring around the cylindrical portion of the supporting sleeve 2, and a second, externally threaded stub 8 for attaching the coupling housing 5 to another member. Instead of being formed with the stub 8 the coupling housing may be symmetrical about a transverse middle plane and comprise two oppositely directed stubs 7 for screwing on of two coupling sockets, whereby the coupling may be used for joining two tubes. Thereby, each half of the coupling will contain a supporting sleeve 1.

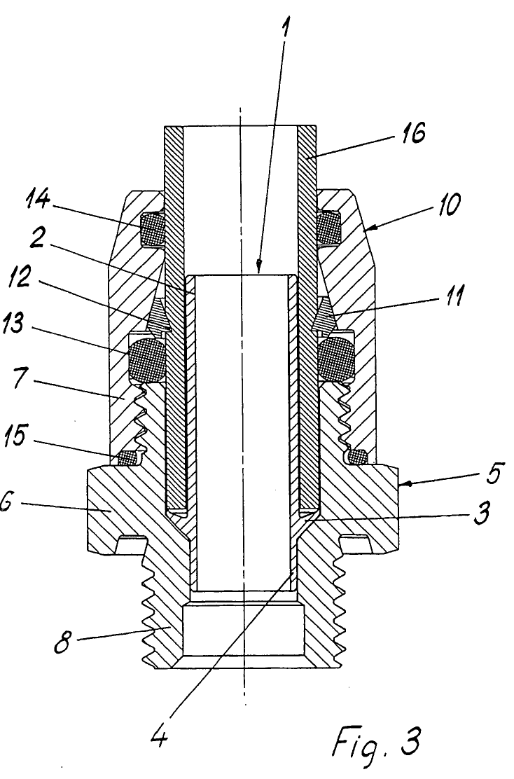

The supporting sleeve 1 is in the examples shown made as a single piece. The cylindrical portion 2 constitutes the active part of the supporting sleeve, by stiffening a tube being inserted in the coupling against external pressure from a clamping ring and/or a sealing ring which in the mounted state surround the tube externally of the portion 2, as shown in FIG. 3. An annulus 9 for insertion of the end of a tube into the coupling housing externally of the portion 2 is mainly adapted to the wall thickness of the inserted tube. The collar 3 causes that the supporting sleeve 1 is retained, and constitutes an end abutment for an inserted tube. The extension 4 constitutes a guide for the supporting tube 1 during insertion into the coupling housing 5 and ensures that the supporting sleeve 1 will be aligned with the longitudinal axis of the coupling housing. In the example shown the extension 4 has a somewhat smaller length and outer diameter than the portion 2, because the extension 4 is not to be exposed to external pressure.

The collar 3 has in the example shown a conical shape externally as well as internally, and in such a manner that the external conus angle is smaller than the internal conus angle; i.e. that the axial thickness of the collar 3 decreases radially outwardly. This means that the stiffness of the collar also decreases outwardly. The collar 3 may also be planar on the upper side.

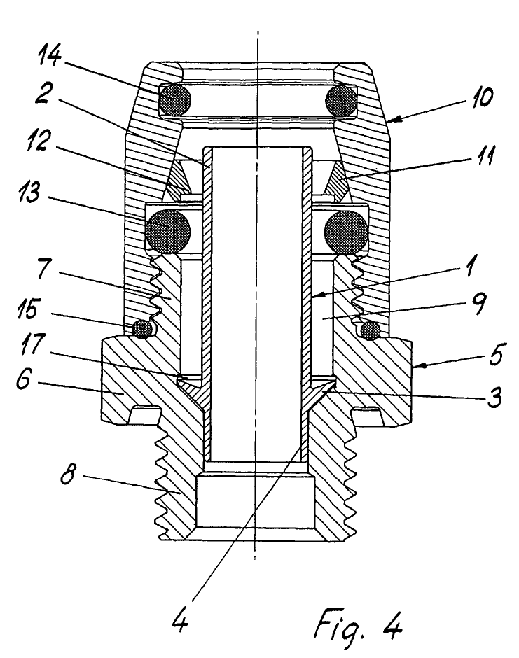

The circumferential edge of the collar 3 is in the example shown somewhat deformed upon insertion, and will press against the wall of the bore due to its elasticity. Due to the conicity of the collar 3 the collar will tend to widen if an attempt is made to pull the supporting sleeve 1 out of the coupling housing, and the resistance against pulling out will increase. The bore in the coupling housing 5 may, as shown in FIG. 4, have an annular groove 17 at the inner end, for accommodating the edge of the collar 3. The collar 3 may have a correspondingly increased radial dimension, whereby the collar is deformed in the mounted state of the supporting sleeve. Also with such an embodiment the collar 3 will tend to widen if an attempt is made to pull the supporting sleeve 1 out of the coupling housing 5.

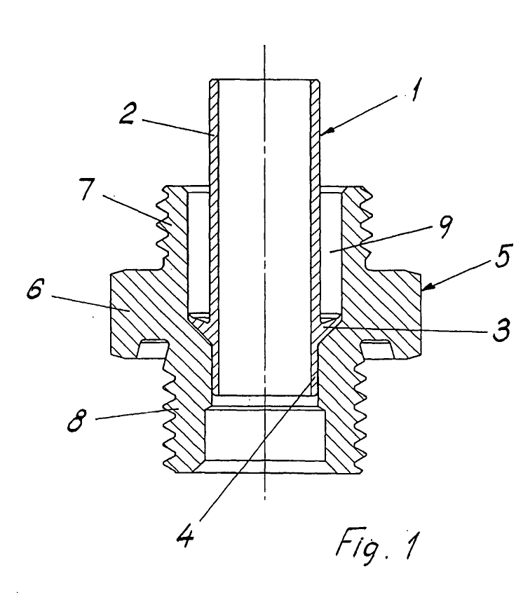

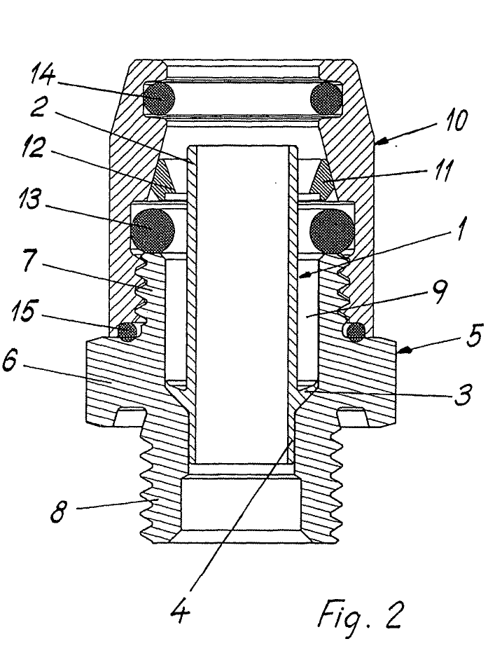

FIG. 2 shows the same coupling housing 5 and the same supporting sleeve 1 as FIG. 1. A coupling socket 10 is here screwed onto the coupling housing 5, and contains a clamping ring 11 and two O-rings 13 and 14. A third O-ring 15 causes sealing between the coupling housing 5 and the coupling socket 10.

FIG. 3 shows the same coupling as FIG. 2 and in addition an end of a tube 16 having been inserted into the coupling by being forced through the clamping ring 11 and the O-rings 13 and 14. It appears that an edge 12 on the clamping ring has been forced somewhat into the tube wall, for retaining of the tube.

FIG. 4 shows mainly the same as FIG. 3, the difference being that the coupling housing 5 is formed with an annular groove 17 at the bottom of the bore which defines the annulus 9 accomodating the tube 16, whereby the outer edge of the collar 3 on the supporting sleeve 1 has expanded into the annular groove 17 when the insertion of the supporting sleeve 1 has been completed. As the collar 3 has a somewhat larger radial dimension than the annular groove 17, the edge of the collar 3 presses against the wall of the annular groove 17. Thereby, the supporting sleeve 1 is locked in the bore.

The supporting sleeve does not need to be unitary as shown. For instance, the collar 3 may be a part mounted on the remainder of the supporting sleeve. The collar 3 may for instance be fastened by being snapped into an annular groove in the portion 2, by being pressed onto the portion 2 or by being glued to the portion 2. This is particularly of interest if it is desirable that the collar is to be of another material than the remainder of the supporting sleeve.

In particular plastics are suited as material for the supporting sleeve, or at least for the collar 3, and preferably hard plastics. When the collar 3 constitutes a separate part, the remainder of the supporting sleeve may for instance be of metal.

The supporting sleeve 1 will give a large resistance against being pulled out, as long as it is aligned with the longitudinal axis of the coupling housing. When the tube has been removed from the coupling housing (upon screwing off the coupling socket 10 which contains the clamping ring 10 and/or the sealing rings 13 and 14), the supporting sleeve may, however, be forced into a somewhat inclined position, whereby the retention thereof in the bore is weakened, and it may be pulled out of the coupling housing 5.

1. A supporting sleeve for use in a tube coupling, in order to cause an internal stiffening against compression of the end of a tube inserted in the coupling, said supporting sleeve being a separate part for being mounted in a bore in the coupling, and said supporting sleeve comprising a deformable collar which externally is conical and narrowing in the direction of insertion, wherein the edge of the collar has a diameter mainly corresponding to or exceeding the diameter of the bore.

2. The supporting sleeve as specified in claim 1, said deformable collar also being internally conical, with a larger conus angle than externally.

3. The supporting sleeve as specified in claim 1, said supporting sleeve comprising a cylindrical portion which shall cause stiffening, and an oppositely directed extension, said collar being situated in the transition between the cylindrical portion and the extension.

4. The supporting sleeve as specified in claim 1, said deformable collar being unitary with the remainder of the supporting sleeve.

5. The supporting sleeve as specified in claim 1, said deformable collar being a separate part mounted on the remainder of the supporting sleeve.

6. The supporting sleeve as specified in claim 1, said deformable collar and the remainder of the supporting sleeve consisting of different materials.

7. The supporting sleeve as specified in claim 1, said deformable collar being of plastics.

8. The supporting sleeve as specified in claim 7, said deformable collar being of hard plastics.

9. A coupling housing for a coupling, for mounting of an internal supporting sleeve in order to cause stiffening against compression of a tube inserted in the coupling, comprising a bore for insertion of the supporting sleeve, which has a circumferential collar of a diameter exceeding the diameter of the bore, said bore having an annular groove of smaller diameter than the collar, and into which the edge of the collar may be inserted.
